(19) United States
(12) Patent Application Publication
(10) Pub. No.: US 2014/0042773 A1
(43) Pub. Date: Feb. 13, 2014

(54) Method for Manufacturing a Motor Vehicle and a Motor Vehicle

(71) Applicants: Christoph Grevener, Gechingen (DE); Uwe Habisreitinger, Freudenstadt (DE); Andreas Krevet, Ehningen (DE); Matthias Mueller, Altensteig (DE); Thomas Stark, Tuebingen (DE); Konrad Wirth, Tiefenbronn (DE); Michael Zuern, Sindelfingen (DE)

(72) Inventors: Christoph Grevener, Gechingen (DE); Uwe Habisreitinger, Freudenstadt (DE); Andreas Krevet, Ehningen (DE); Matthias Mueller, Altensteig (DE); Thomas Stark, Tuebingen (DE); Konrad Wirth, Tiefenbronn (DE); Michael Zuern, Sindelfingen (DE)

(73) Assignee: Daimler AG, Stuttgart (DE)

(21) Appl. No.: 13/996,902

(22) PCT Filed: Oct. 27, 2011
(86) PCT No.: PCT/EP2011/005430

§ 371 Date: Oct. 16, 2013

(30) Foreign Application Priority Data
Dec. 23, 2010 (DE) 10 2010 055 957.1

(51) Int. Cl. B62D 29/00

(52) U.S. Cl. CPC B62D 29/00
USPC 296/181.1; 29/428; 29/458

(57) ABSTRACT

The invention relates to a method for the production of motor vehicles, in particular personal motor vehicles, wherein a plurality of moveable outer skin elements (90) forming the outer skin of the motor vehicle, in particular doors (74), hoods (76) or hatches (78), are applied to a respective shell (42) of the motor vehicle, wherein the moveable outer skin elements (90), in particular the doors (74), hoods (76) or hatches (78) are only applied to the respective shell (42) of the motor vehicle in or after an assembly line, in particular in or after a main assembly line (46). Moreover, the invention relates to a motor vehicle, in particular a personal motor vehicle, having a shell (42), which has a cathodic dip coating or similar corrosion protection coating added to it and to which a plurality of outer skin elements (90, 80) forming the outer skin are applied, wherein the shell (42) of the motor vehicle only has the cathodic dip coating or similar corrosion protection coating added to it.

The invention relates to a method for manufacturing motor vehicles according to the preamble of claim 1. The invention furthermore relates to a motor vehicle according to the preamble of claim 6.

It is commonly known from the series construction of personal motor vehicles to subject the respective body or the respective shell to a cathodic dip coating or similar corrosion protection coating after the shell has been produced. Before this cathodic dip coating, moveable extension elements such as doors, hoods or hatches are already fastened and aligned to the respective body in the shell production, and thus are also guided together with the shell through the cathodic dip coating. Also, during the typical subsequent topcoating, these moveable extension elements are left on the corresponding shell.

After the coating, it has so far been typical to remove at least some of the extension elements from the corresponding shell in order to equip these with further components, for example. Thus, it is well-established to once again remove respective doors from the corresponding shell in order to equip these with, for example, window panes and window pane lifting modules, with wing mirrors, with storage compartments or with door interior trim. In connection with these configurations, the complete extension elements must then be fixed and aligned to the shell again.

The object of the present invention is therefore to create a method for the production of motor vehicles as well as a motor vehicle itself of the aforementioned type, by means of which a simplified manufacturing of the respective vehicle can be carried out.

This object is solved according to the invention by a method and a motor vehicle having the features of claims 1 and 6. Advantageous embodiments containing expedient and significant developments of the invention are specified in the remaining sub-claims.

To create a method of the aforementioned type, by means of which the manufacturing of the motor vehicle is significantly simplified, provision is made according to the invention for the outer skin elements, in particular the doors, hoods or hatches, to be applied to the respective shell of the motor vehicle only after an assembly line, in particular in or after a main assembly line. In contrast to the hitherto existing prior art, wherein the moveable outer skin elements such as doors, hoods or hatches had to already be applied to the corresponding shell during the shell production and had to be subsequently removed again, provision is thus made according to the invention to dispense with, in particular, this step of the repeated removal of the components. In fact, provision is made according to the invention to fasten said moveable extension components such as doors, hoods or hatches to the respective shell only at a later point in time, specifically only in or after an assembly line, in particular in or after a main assembly line. The outer skin elements are thus fastened to the corresponding shell for the first time during assembly.

Moreover, the measures according to the invention have the advantage that the moveable outer skin elements such as doors, hoods or hatches do not necessarily have to be suitable to be guided through the cathodic dip coating or similar corrosion protection coating. In this way, a high level of freedom is achieved for the selection of the materials of the outer skin elements and for the body, since it is no longer necessary for the body and outer skin elements to pass through the coating processes together. This can now occur in separate processes. This enables such moveable outer skin elements to also be constructed from a polymer, for example. A further advantage is that, due to the coating, provisory process influences can be considerably reduced. A further advantage is that the damage risk of respective outer skin elements is considerably reduced when these are only fastened to the shell at a later point in time of the production of the motor vehicle. Moreover, due to the outer skin elements being left for longer, improved accessibility arises, for example, to the interior of the motor vehicle.

In a further embodiment of the invention, it has been proven to be advantageous if the respective shell of the motor vehicle only has the cathodic dip coating or similar corrosion protection coating added to it. In other words, in a further embodiment of the invention, it is particularly advantageous if a top coat for the shell or the body of the motor vehicle can be dispensed with and, as a consequence, if the complete covering of the shell can be done by moveable and non-moveable outer skin elements. Thus, by saving the top coat, a considerable cost-saving potential arises.

A further advantage of the method according to the invention arises in that it is not necessary to disassemble and subsequently reassemble the moveable shell parts on the body before or after the shell has been produced.

The advantages described above in connection with the method according to the invention apply in the same way for the motor vehicle according to claim 6.

Further advantages, features and details of the invention arise from the following description of a preferred exemplary embodiment and by reference to the drawings; the following are shown:

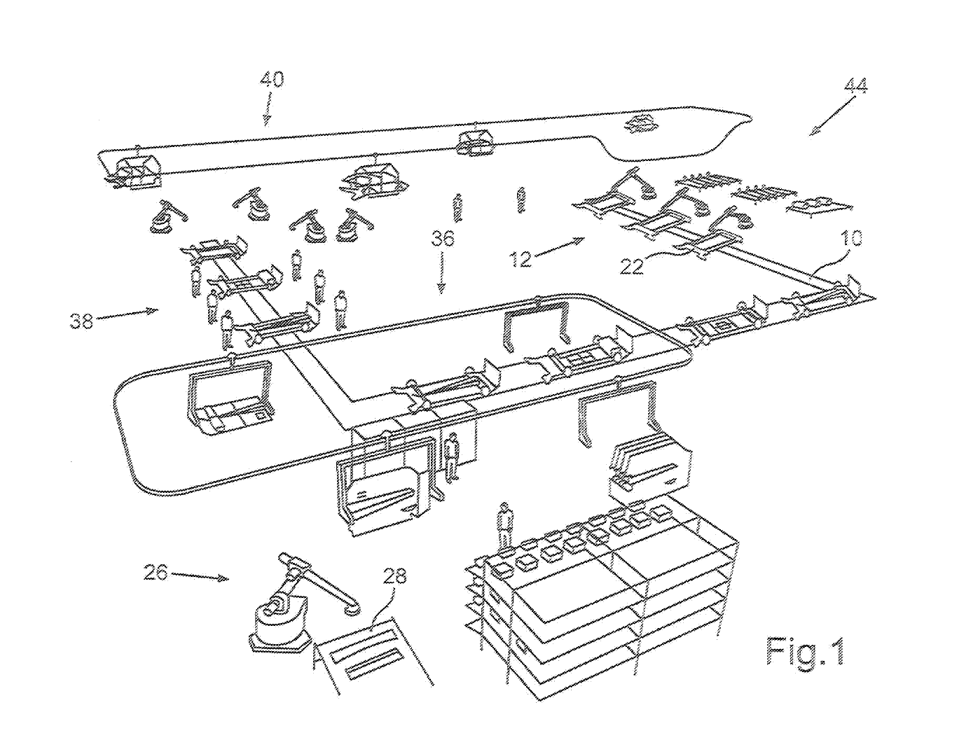

FIG. 1 a schematic perspective view onto an assembly line for the pre-assembly of a respective chassis and a respective drive train of the corresponding motor vehicle, as well as a floor module of the respective motor vehicle, which are connected to one another in line with a so-called “engagement” and pre-assembled before these are connected to a respective corresponding shell of the corresponding motor vehicle in line with a so-called “marriage”, wherein the motor vehicle is equipped with wheels after the marriage;

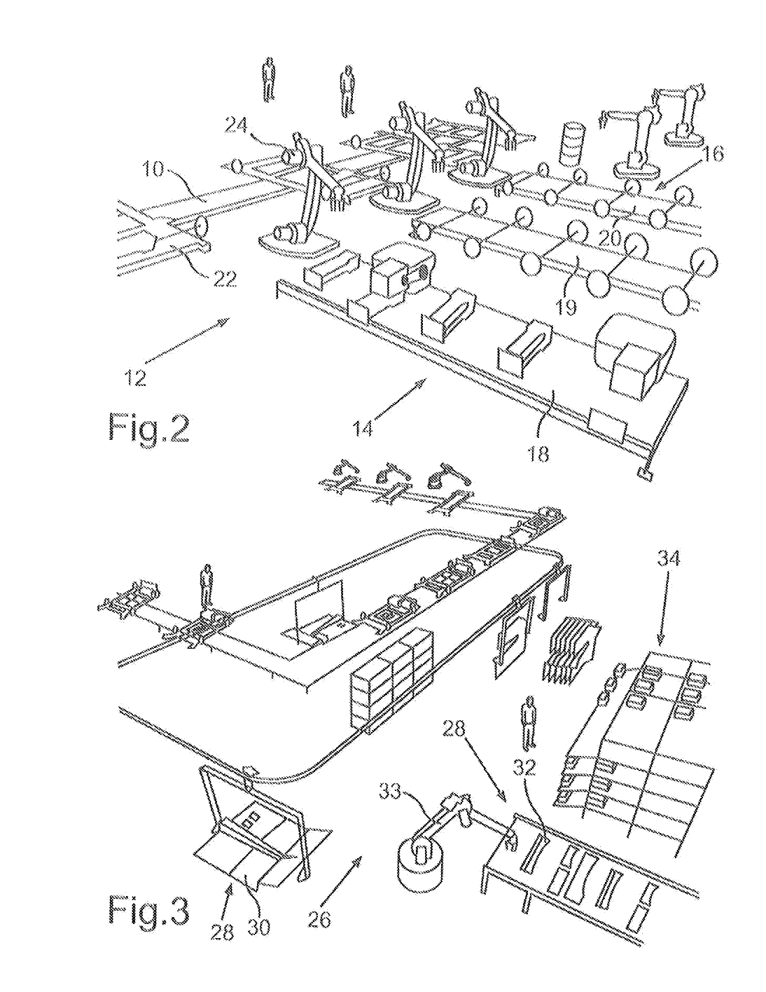

FIG. 2 a schematic perspective view onto the pre-assembly of the drive train and of the chassis within the assembly line shown in the FIG. 1;

FIG. 3 a schematic perspective view onto a pre-assembly of the floor module within the assembly line according to FIG. 1;

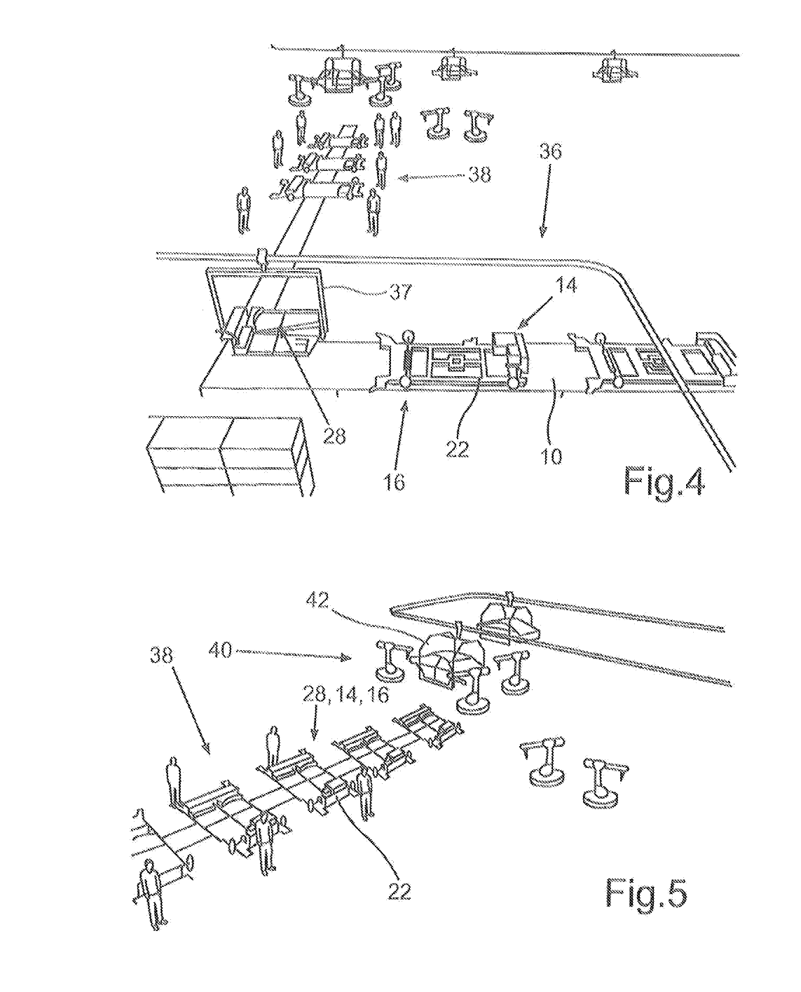

FIG. 4 a schematic perspective view onto the engagement of the chassis and the drive train with the respective floor module within the assembly line according to FIG. 1;

FIG. 5 a schematic perspective view onto the marriage of the respective shell of the motor vehicle with the respective chassis and drive train or the respective floor module within the assembly line according to FIG. 1;

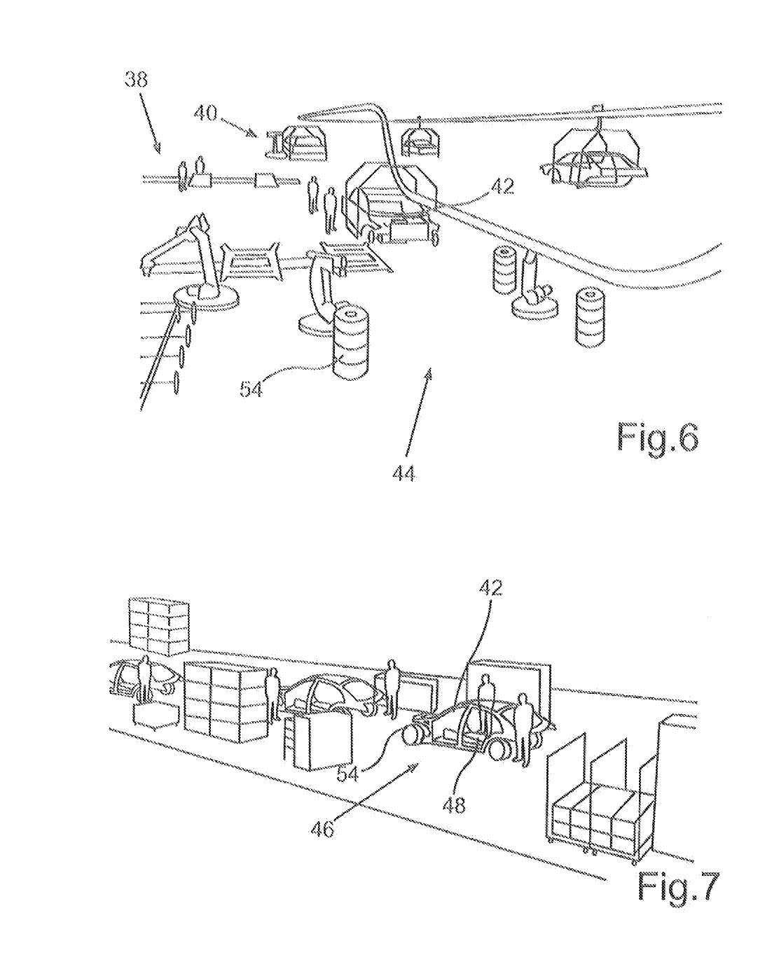

FIG. 6 a schematic perspective view onto an assembly station of the assembly line according to FIG. 1 after the marriage, within which the motor vehicle is equipped with the vehicle wheels;

FIG. 7 a schematic perspective view onto assembly stations of a main assembly line located downstream of the assembly line according to FIG. 1, in which the respective shell of the motor vehicle is equipped with the interior installation;

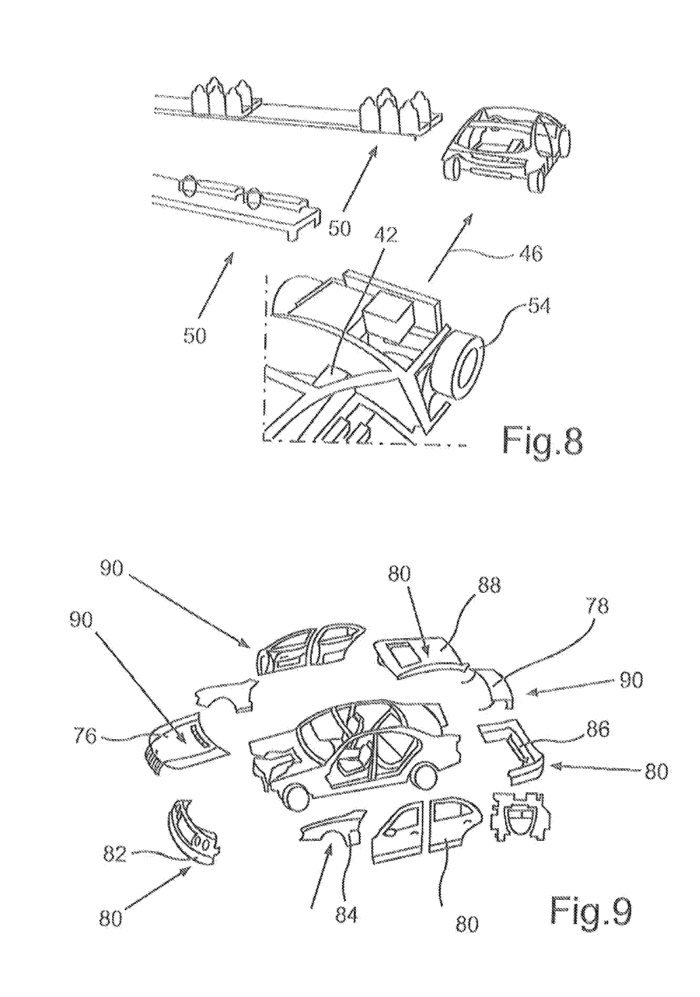

FIG. 8 a further sectional perspective view onto respective assembly stations of the main assembly line, within which respective constructional units and components of the interior installation are provided for the assembly; and in

FIG. 9 a perspective view onto the respective shell of the motor vehicle, which has the chassis, drive train and interior installation added to it, which, in connection to the interior installation, have moveable and non-moveable outer skin elements, which form the shell, added to it.

In FIG. 1, in a schematic perspective view, an assembly line arranged upstream of a main assembly line (to be illustrated in greater detail) for the assembly of motor vehicles is depicted. This assembly line 10 is to be furthermore illustrated in detail in conjunction with FIGS. 2 to 6.

Firstly, in conjunction with FIG. 2, a first region 12 of the assembly line 10 can be detected, which shows the pre-assembly of a respective drive train 14 and a respective chassis 16 of the corresponding motor vehicle. Here, FIG. 2 shows the region 12 in a schematic and sectional perspective view.

As can be detected from FIG. 2, the region 12 of the assembly line 10 comprises a supply device 18 for a respective different drive or drive train 14, which is provided depending on the respective drive concept of the motor vehicle. Respective supply devices 19, 20 for a front axle or rear axle of the respective chassis 16 can be detected behind the supply device 18 for the respective drive or drive train 14. Moreover, further chassis elements or components can be provided as well as the front and rear axle.

As can now be detected from FIG. 2, the individual components of the drive train 14 and the chassis 16 are arranged on a respective auxiliary carrier 22, which is conveyed on the assembly line 10. This takes place by means of corresponding robots 24.

The respective components of the drive train 14 and the chassis 16 are provided in sequence on the supply devices 18 to 20 and positioned on the respective auxiliary carrier 22, which is allocated to a motor vehicle that is to be produced accordingly. The sequential arrangement and selection of the individual components of the drive train 14 and the chassis 16 thus take place depending on a respective drive concept of the motor vehicle.

In conjunction with FIG. 3, which in particular shows a second region 26 of the assembly line 10 in a further sectional and schematic perspective view, the pre-assembly of a floor module 28 becomes clear. This floor module 28 comprises a floor shell 30, on which a plurality of constructional units 32 can be arranged as equipment. These constructional units 32 are variant-specific or variant-dependent on the respective drive concept of the corresponding motor vehicle. Here, both individual components or constructional elements can be understood to be constructional units, as well as assemblies or structural groups. It is also conceivable, for example, to also add heat shields, hydraulic lines or fuel lines to the floor shell 30, as well as air lines, fuel lines or suchlike. It is also conceivable to add a corresponding drive-concept-conditional energy storage device, for example a tank, a battery or suchlike, to the floor shell 30. Corresponding control devices, which are required depending on the corresponding drive concept of the motor vehicle, can also be applied to the floor shell 30. Electrical constructional units 32, such as cable harnesses, in particular the main cable harness, can also be fastened to the floor shell 30 in order to hereby complete the floor module 28.

The individual constructional units 32 are hereby applied to the floor shell 30 by means of a robot 33, for example. In the present case, a shelf 34 is depicted, on which the constructional units 32, for example, are provided in sequence.

In conjunction with FIG. 4, a third region 36 of the assembly line 10 is depicted in a sectional and schematic perspective view. In this third region, there takes place a so-called engagement of the drive train 14 or chassis 16 pre-assembled in the first region 12 and the floor module 28 pre-assembled in the second region 26. Here, it can be detected that the auxiliary carrier 22 bearing the drive train 14 and the chassis 16 is introduced from below and the floor module 28 is fitted from above on the upper side via a corresponding transportation device 37. Thus, due to the engagement, there arises a pre-assembled arrangement of drive train 14, chassis 16 and floor module 28, which is attuned to the respective variant of the motor vehicle or to the respective drive concept of the motor vehicle.

Moreover, in FIG. 4, further assembly stations 38 can be detected, within which, for example, a connection of the corresponding components and constructional units 32 of the drive train 14, the chassis 16 and the floor module 28 can take place. As well as the connection of the individual components and constructional units 32, lines or energy storages devices such as tanks, for example, can be filled. Moreover, electrical control devices, for example, can be activated. After the engagement, the individual components or constructional units 32 are thus preferably ready for operation.

A fourth region 40 of the assembly line 10 can be detected in FIG. 5, in which a respective shell 42, in line with a so-called marriage with its respective drive train 14, chassis 16 and floor module 28, which have first been combined with one another in the third region 36 in line with the engagement, is connected. To that end, the shell 42 has a corresponding recess for the floor module 28, which is applied accordingly. The drive train 14 and the chassis 16, as well as the floor module 28, are also connected to the shell 42 of the motor vehicle. After the connection to the shell 42, the auxiliary carrier 22, which has served to bear the drive train 14, the chassis 16 and the floor module 28, is conveyed back to the first region 12. At this point, it is to be noted that the present shell 42 is a self-supporting body of a personal motor vehicle or a self-supporting structure of a motor vehicle in general.

Since, as has already been illustrated, the respective variant of the drive concept takes place by the corresponding formation of the drive train 14, the chassis 16 and the floor module 28, the shell 42 is substantially configured without variants. This means that the variation that is necessary based on the drive concept is at least substantially pre-displaced into the pre-assembly of the drive train 14, the chassis 16 and the floor module 28.

Finally, FIG. 6 shows a further assembly station 44 of the assembly line 10, wherein the motor vehicle has motor vehicle wheels added to it. This has the particular advantage that conveyance and transportation devices, which must receive and/or bear the weight of the motor vehicle, can thus be dispensed with. In fact, the vehicle can be rolled off from this assembly station 44 due to the further assembly, in particular the main assembly line that is still to be illustrated further below. This can either take place as operated by external power or by the drive of the motor vehicle itself.

FIGS. 7 and 8 show respective perspective views of a main assembly line 46, which is connected to the assembly line 10. By contrast to the hitherto existing assembly method, the equipping of the shell 42 with an interior installation 48 first takes place after the marriage. This interior installation 48 in particular comprises the installation of the dashboard, the seating units, the interior trim, the central console and a plurality of further devices such as the pedals, the steering column or other further equipment. For this, FIG. 8 shows respective assembly stations 50, wherein, for example, corresponding seating units or dashboards are assembled. Moreover, FIG. 7 shows that, for example, the displacement of the shell 42 can take place in the main assembly line 46.

The adjustment of functional elements of the motor vehicle can be preferably take place within the main assembly line 46, and therefore in particular to reduce the volumes in the region of the end of the main assembly line 46. Thus, for example, a chassis adjustment, a headlight adjustment or a calibration and start operation of driver assistance systems, in particular chassis assistance systems, can be displaced from the main assembly line 44 to the pre-assembly. Thus, for example, corresponding adjustments of functional elements in connection with the engagement and before or after the marriage can be monitored in the region of the pre-assembly and before the main assembly line 46. Likewise, due to the possibility for autonomous movement of the motor vehicle, it is possible for this to be moved onto corresponding chassis dynamometers or into regions for rain testing.

Finally, FIG. 9 shows the shell 42 of the motor vehicle in a schematic perspective view, wherein the interior installation 48 has already been implemented. It can be detected that, as well as the interior installation 48, the front windscreen and rear windscreen have also been adjusted.

In a further method step within the main assembly line 46, the shell 42 of the motor vehicle has a plurality of outer skin elements that are still to be described individually added to it after the interior installation 48 has been equipped, which form the outer skin of the motor vehicle.

Firstly, from FIG. 9, a plurality of moveable outer skin elements 90 can be detected, which are designed individually as side doors 74, the bonnet 76 and the boot hatch 78. Moreover, a plurality of non-moveable outer skin elements 80 are also applied to the shell 42, wherein these are, in the present case, individually a front end module 82, front or rear mud guard 84, a rear bumper 86 and a roof module 88.

These moveable outer skin elements 90 and non-moveable outer skin elements 80 form, in total, the outer skin of the motor vehicle in the manner that is to be described in greater detail below.

One peculiarity of the method for the production of the personal motor vehicle is that, in the present case, particularly the moveable outer skin elements 90, so the doors 74, the bonnet 76 and the boot hatch 78 have not already been fastened to the shell 42 in the production of the shell, but rather for the first time in or after an assembly line, in particular in or after the main assembly line 46. In other words, these moveable outer skin elements 90 are only applied to the shell 42 once, and not as has been typical to-date—first applied during the shell production and then removed once again for equipment with diverse components.

There thus arises, in the present method for the production of the motor vehicle, a clearly simpler handling of the moveable outer skin elements 90, which on their side do not pass through the cathodic dip coating or similar corrosion protection coating or the top coat of the shell 42 itself, but rather are produced and, if necessary, coated separately. In line with this, these moveable outer skin elements 90 are completely equipped. When these are doors 74, this means, for example, that these are equipped with the window pane, the window pane lifting devices, the respective wing mirror and the respective interior trim. It is only after the complete pre-assembly of the individual moveable outer skin elements 90 that these are ten fastened to the shell 42 for the first time. This does not only have the advantage that the moveable outer skin elements 90 do thus no longer have to be removed after the cathodic dip coating and then reapplied, but also that these can also be produced from other materials due to the fact that they are no longer guided through the cathodic dip coating. It is thus conceivable, for example, to construct these moveable outer skin elements 90 from a polymer, which, due to the guiding through the cathodic dip coating, would not have been readily possible up to now.

Also, the non-moveable outer skin elements 80 are only applied to the shell 42 within the main assembly line 46. For example, when a mud guard is concerned, this has the advantage that their resting time on the shell 42 is as low as possible, such that the possibility for damaging these non-moveable outer skin elements 80 is considerably reduced.

Overall, a method is thus created, wherein the moveable and non-moveable outer skin elements 90, 80 can be modularised and can only be applied to the shell 42 of the motor vehicle during the installation. Here, it is conceivable, for example, for individual outer skin elements 90, 80, to pass through a separate cathodic dip coating or similar corrosion protection coating and a top coat, before these are fastened to the shell 42 for the first time. The fastening of the respective outer skin elements 90 can thus in particular take place according to a method, as this can be gleaned as known from WO 2004/02 66 72 A2, for example, the content of which is hereby to be considered as explicit. This has, for example, the advantage that the respective coating does then not have to be applied for the entire shell, but rather, if necessary, only for the respective outer skin elements 90 or 80 that are to be coated. Moreover, the temperature in the coating can then be better adjusted to the outer skin elements 90, 80, since these are coated separately from the shell 42.

As well as the improved method procedure for the production of the motor vehicle, a motor vehicle itself is, in the present case, also to be created, the shell 42 of which has a cathodic dip coating or similar corrosion protection coating added to it and to which a plurality of outer skin elements 90, 80 forming the outer skin are applied, wherein the shell of the motor vehicle only has the cathodic dip coating or similar corrosion protection coating added to it. In other words, during the embodiment of the motor vehicle according to the present exemplary embodiment, a top coat of the shell 42 can be dispensed with. This is in particular enabled by the fact that the shell 42 is completely covered by the outer skin elements 90, 80. It is in particular to be understood hereunder that, when the doors 74, bonnet 76 and boot hatch 78 are closed and when non-moveable outer skin elements 80 are attached, a closed outer skin is created by these, which completely covers the shell 42 or the body of the personal motor vehicle located behind it. Since the shell 42 thus cannot be detected from the outside, no top coat is required for this. In fact, it is sufficient if the shell 42 only has the cathodic dip coating or similar corrosion protection coating added to it. Since the shell—under the above-described conditions—thus no longer has visible parts, a top-coat-free body is possible. The body coming from the cathodic dip coating therefore does not necessarily have to be crash-proof. This is crash-proof at the latest when the floor module 28 is fixed. Until then, the most important requirement is compliance with the specifications of the process loading conditions.

Non-detectable hinge joints, via which the moveable outer skin elements 90 are held to the shell 42, are, in this case, for example, not coated with the same colour as the vehicle, but rather matt black, for example. If, on the other hand, they had already been fastened to the respective moveable outer skin elements 90, necessary degrees of freedom for adjustment would have been lost.

1. Method for the production of motor vehicles, in particular personal motor vehicles, wherein a plurality of moveable outer skin elements (90) forming the outer skin of the motor vehicle, in particular doors (74), hoods (76) or hatches (78), are applied to a respective shell (42) of the motor vehicle
characterised in that,
the moveable outer skin elements (90), in particular the doors (74), hoods (76) or hatches (78) are only applied to the respective shell (42) of the motor vehicle in or after an assembly line, in particular in or after a main assembly line (74).

2. Method according to claim 1,
characterised in that,
the moveable outer skin elements (90), in particular the doors (74), hoods (76) or hatches (78) are applied to this for the first time after passing through a cathodic dip coating or similar corrosion protection coating of the respective shell (42) of the motor vehicle.

3. Method according to claim 2,
characterised in that,
the respective shell (42) of the motor vehicle only has the cathodic dip coating or similar corrosion protection coating added to it.

4. Method according to claim 1,
characterised in that,
the outer skin elements (90), in particular the doors (74), hoods (76) or hatches (78), pass through a separate cathodic dip coating or similar corrosion protection coating from the respective shell (42) of the motor vehicle.

5. Method according to claim 1,
characterised in that,
plastic elements are provided as moveable outer skin elements (90), in particular as doors (74), hoods (76) or hatches (78).

6. Motor vehicle, in particular a personal motor vehicle, having a shell (42), which has a cathodic dip coating or similar corrosion protection coating added to it and to which a plurality of outer skin elements (90, 80) forming the outer skin of the motor vehicle are applied,
characterised in that,
the shell (42) of the motor vehicle only has the cathodic dip coating or similar corrosion protection coating added to it.

7. Motor vehicle according to claim 6,
characterised in that,
the shell (42) of the motor vehicle is completely covered by the outer skin elements (90, 80).

8. Motor vehicle according to claim 6,
characterised in that,
moveable outer skin elements (90), in particular doors (74), hoods (76) or hatches (78) are designed as plastic elements.
